(19) United States
(12) Patent Application Publication
(10) Pub. No.: US 2009/0194714 A1
(43) Pub. Date: Aug. 6, 2009

(54) Fiber Optic Liquid Level Sensor

(75) Inventors: Robert B. Nelson, Snoqualmie, WA (US); David G. O'Connor, North Bend, WA (US)

Correspondence Address: ASEMBLON, INC;JEFFREY B. OSTER -- LEGAL DEPARTMENT, 15340 NE 92ND ST, SUITE B, REDMOND, WA, 98052, US

(73) Assignee: Asemblon, Inc.

(21) Appl. No.: 12/327,800

(22) Filed: Dec. 3, 2008

Related U.S. Application Data
(60) Provisional application No. 61/015,523, filed on Dec. 20, 2007.

(51) Int. Cl. G01N 21/85; B26D 7/00

(52) U.S. Cl. 250/577; 83/23

(57) ABSTRACT

There is disclosed a fiber optic liquid level sensor apparatus that functions using total internal reflection and an index of refraction. More specifically, there is disclosed a fiber optic liquid level sensor apparatus comprising two fiber optic strands, each having a first end and a second end, substantially oriented in parallel to each other, wherein the second ends of both strands are attached to each other.

### CROSS REFERENCE TO RELATED APPLICATION

This patent application claims priority to U.S. Provisional Patent Application 61/015,523 filed 20 Dec. 2007.

### TECHNICAL FIELD

The present disclosure provides a fiber optic liquid level sensor apparatus that functions using total internal reflection and an index of refraction. More specifically, the present disclosure provides a fiber optic liquid level sensor apparatus comprising two fiber optic strands, each having a first end and a second end, substantially oriented in parallel to each other, wherein the second ends of both strands are attached to each other.

### BACKGROUND

It is frequently necessary to measure or monitor the level of a liquid in a tank or a container. Or it is necessary to measure or monitor whether or not a molecule or formulation is passing through a reactor vessel in a liquid or gaseous state. Often, measurement of liquid levels has been done by means of a float-type device. However, other means to measure liquids at a particular location or liquid levels include a plurality of optical sensors that can be positioned on a tank wall at various vertically-spaced elevations.

Essentially a transparent body is provided with a conical or prismatic tip end portion. Light is propagated within the body toward the tip end portion, and is reflected by two sensors at the tip end portion back toward the receiver. The body is typically glass and has a refractive index of about 1.50. If the tip end portion is exposed to air above the surface of the liquid, the “critical angle” at which all light is reflected within the body is calculated from the equation: sin Θ_{c}=n₂/n₁, where Θ_{c} is the “critical angle”, n₂ is the index of refraction of the fluid (i.e., air) to which the tip is exposed, and n₁ is the index of refraction of the material (i.e., glass) of the tip end portion. This, for air, n₂=1.00 and for glass, n₁=1.50. Therefore, the critical angle for a glass body with respect to air is about 42°. If the tip end is submerged in a liquid, such as water (i.e., n=1.33) then the “critical angle” with respect to water is about 62.5°.

The principle of total internal reflectance occurs if the tip end portion is exposed to air, but that light is refracted if the tip end portion is submerged in liquid. This has been used to measure the level of a liquid in a tank.

The index of refraction is the ratio of the speed of light in a vacuum to the speed of light is a substance. It is represented by the letter n and can be found in the equation n=c/v, wherein c is the speed of light in a vacuum and v is the speed of light in the material. The index of refraction of a material can be determined by the formula n=λ₀/λₙ, wherein λ₀ is the wavelength of the light in a vacuum and λₙ is the wavelength in the material. The refractive index can also be determined by Snell's Law, that states that n₁ sin Θ₁=n₂ sin Θ₂, where n₁ and n₂ are the indices of refraction in the two media, and Θ₁ represents the incident ray and Θ₂ represents the refracted ray.

The critical angle is the angle of incidence above which total internal reflection occurs. The angle of incidence is measured with respect to the normal and refractive boundary. The critical angle Θ_{c} is given by Θ_{c}=arcsin (n₂/n₁) wherein n₂ is the refractive index of the less dense medium, and n₁ is the refractive index of the denser medium. This equation is a simple application of Snell's Law where the angle of refraction is 90°. If the incident ray is precisely at the critical angle, the refracted ray is tangent to the boundary at the point of incidence. For visible light traveling from glass into air (or vacuum), the critical angle is approximately 41.8°. If this fraction: n₂/n₁ is greater than 1, then arcsin is not defined, meaning that total internal reflection does not occur even at very shallow or grazing incident angles. So the critical angle is only defined for n₂/n₁≦1.

### SUMMARY

The present disclosure provides a fiber optic liquid level sensor device that uses two optical fiber strands, joined at their distal ends, for sensing various environmental parameters. More specifically, the disclosed sensor produces a signal corresponding to the amount of evanescent wave light loss from the optical fibers that is lost at the distal ends into an absorbing medium (e.g., liquid) in contact with the distal end of the optical fibers.

The present disclosure provides an optical sensor comprising a light source, a light detector and signal generator, and two optical fibers having cladding surrounding the fibers except at the distal ends where the distal ends of both fibers are joined. Preferably, the joining of the distal ends of the optical fibers forms rounded a “V” shape, wherein cladding is removed for from about 0.1 mm to about 5 mm of the distal end from each fiber. Preferably, the light source is a device selected from the group consisting of LED, tungsten light sources, light-emitting diodes composed of gallium arsenide, and laser diodes composed of gallium arsenide and/or aluminum gallium arsenide materials, Phosphors. Preferably, the light detector is a device selected from the group consisting of photo transistor, photo diode, photo cell, electro voltaic cell, phosphors, and combinations thereon. Preferably, the signal generator is a device selected from the group consisting of LED, Tungsten, Laser, phosphors, and combinations thereof. Preferably, the two optical fibers are oriented substantially in parallel except at their distal ends where the two optical fibers form a rounded “V” shape. Preferably, the distal ends of the two optical fibers have had cladding material removed.

### BRIEF DESCRIPTION OF THE FIGURES

FIG. 1 shows a schematic of the disclosed optical sensor device in an air or gaseous medium wherein the cladding (2) is removed at the joined distal ends (3). The schematic shows that light does not leave the fiber when the distal ends without cladding is immersed in a gaseous or air medium.

FIG. 2 shows a schematic of the disclosed optical sensor device in a liquid medium wherein the cladding (2) is removed at the joined distal ends (3). The schematic shows that light is not longer internally reflected when immersed in a liquid medium.

FIG. 3 shows a circuit design for measuring the light that is internally reflected. A drop off of light will indicate that the distal ends of the fiber optic strands are immersed in a liquid medium.

### DETAILED DESCRIPTION

The present disclosure provides a fiber optic liquid level sensor device that uses two optical fiber strands, joined at their distal ends, for sensing various environmental parameters.

The term “medium” as used herein describes any substance, the presence (or absence) of which is detected by the sensor described herein. Generally, a “medium” is any fluid, including a gas or a liquid, which absorbs light at the wavelengths emitted by the sensor's light source.

The term “sensed environment” as used herein, is generally the environment surrounding the disclosed sensor and includes any “medium” in contact with the disclosed sensor's non-cladded distal end (that is, its “sensing surface”).

The term “amount of light” and “intensity of light” as used interchangeably herein, and describe the number of photons that, for example, are generated by the light source, travel through the optical fiber, are present in the evanescent wave, and are received at the light source.

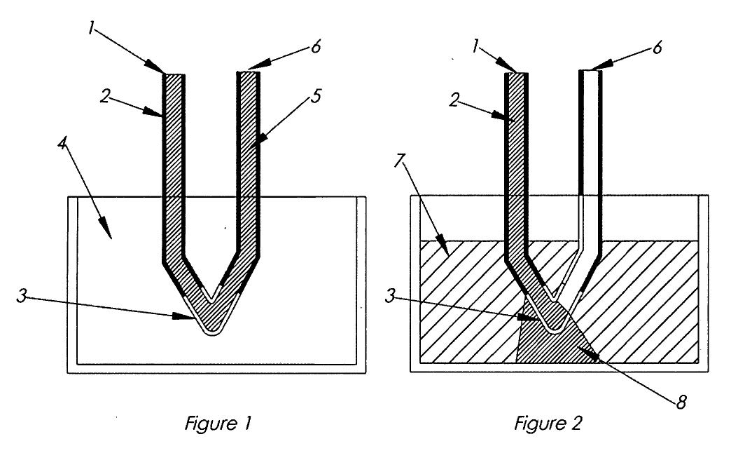

With regard to FIG. 1, this shows the disclosed fiber optic liquid level sensor device in air as a medium. Light enters from a light source (1), travels down the fiber having a cladding shell (2) to the distal end of the sensor (3) that is immersed in the medium (4). As the distal end of the sensor (3) is without cladding, light will be internally reflected if the medium is a gas fluid (not a liquid) as shown in FIG. 1. The light then travels back up the sensor into a cladded region (5) to be detected in the light detector (6). Light travels down the length of the fiber and back out the other end. Only a small and insignificant percentage of light is lost to the air through coupling.

With regard to FIG. 2, this figure shows the same disclosed fiber optic liquid level sensor device in a liquid as a medium (7). Light from a light source (1) enters one end of the fiber and travels down its length of the fiber having a cladding shell (2). Light reaches the medium (7) but the medium is a liquid in FIG. 2. Light will reach the distal end of the sensor device where the cladding is not present (3). Once the light reaches the liquid/fiber surface interface, the index of refraction changes and the fiber starts losing light to the liquid (8). Whatever light was not reflected into the liquid medium will travel back up the fiber optic sensor and be detected at the sensor device (6). Since most if not all light is lost within the liquid, there should be little or no light present at the output and detected by the sensor.

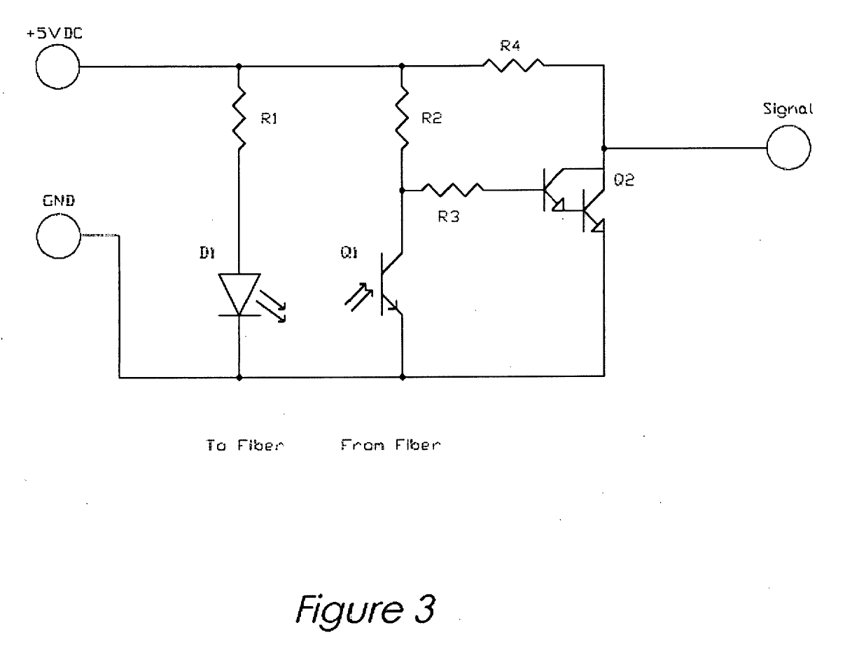

With regard to FIG. 3, the circuit depicted illustrates a control circuit that controls the light source and the light detector located at opposite ends of the fiber optic sensor device. The circuit is comprised of two sections, the light source and the detector. The light source can be any light converting device. Examples of appropriate light sources include, but are not limited to, LED, tungsten light sources, light-emitting diodes composed of gallium arsenide, and laser diodes composed of gallium arsenide and/or aluminum gallium arsenide materials, stimulated Phosphors, and combinations thereof. The detector section is any device that converts light back into an electrical signal. Examples of appropriate detectors include, but are not limited to, photo transistor, photo diode, photo cell, electro voltaic cell, phosphors, and combinations thereof.

In the disclosed embodiment, an LED Light Emitting Diode with an output in the infrared was used (Sharp Part Number PT100MC0MP). The sensor has three terminals, one for positive DC voltage, one for ground or DC return and the third for an output signal. Current comes in the first terminal (positive DC voltage) and passes along to the two operating sections, light source and detector. Current goes through a current limiting resistor and to the anode of the LED. The current through the LED was set for approximately 20 milliamps. Current then returns back to the third terminal (output signal) where it returns to the power source. The light from the LED is optically coupled to the input end (near end) of one thread (input thread) of the fiber sensor device.

Current coming in the first terminal and into the detector section passes through a second resistor (R3). The second side of the resistor is connected to the collector of a photosensitive NPN transistor. The emitter side of the resistor is connected back to the third terminal, which is connected to the power source. The base of the transistor is exposed to the outside environment through an infrared transparent material. The base of the transistor is optically coupled to the return side of the optical fiber. The collector of the transistor is coupled through a resistor to the base of an NPN darlington high gain transistor. This provides a base drive current to the high current transistor output stage. The emitter of the transistor is connected back to the third terminal of the sensor. The output stage of the sensor can be set up to be open collector or an active drive. Open collectors allow the darlington transistor to directly drive an output device up to 300 milliamps. In the case of the present embodiment, for example, the pull up resistor from the first terminal to the collector of the transistor is eliminated. If an active pull up is required then the resistor from the first terminal to the collector would be added. Typically a one thousand ohm resistor is preferred.

Light entering the base of the photosensitive transistor biases the transistor to the “on” state. This causes current to flow through the transistor pulling the collector close to the ground. This, in turn, causes the base of the output stage transistor to be pulled low, turning the transistor to the “off” position. If the transistor is off, current does not flow, causing the output signal terminal to be pulled high if the active pull up, or to logic 1 if the resistor is present. Alternatively, no current flowing will disable the output device in the case of a relay coil.

If light is removed from the base of the photosensitive transistor caused by optically coupling into the liquid, the transistor turns off or no current flows. The resistor connected to the collector causes current to flow, but not through the collector to the emitter of the transistor, but through the base to the emitter of the darlington transistor. This biases the output stage transistor on causing the output terminal to be pulled low or to logic 0.

The present disclosure provides a highly sensitive liquid level detector, wherein the sensitivity is attributable to the “U” shape geometry of the distal end of the device and the lack of cladding at the distal end. Without being bound by theory, the reason for the sensitivity is the “U” shape of the bend that optimizes the evanescent wave present in this portion of the fiber, including a circular (cross section) nature of the fiber. By virtue of the “U” shape and lack of sharp angles, the geometry and lack of cladding material at the distal ends provides a continuous evanescent wave along the bend of the U shape that can be depleted only by having a liquid/fiber surface interaction.

The disclosed optical fiber is made from a light conducting material. Many such fibers are available from manufacturers, including Corning, and ThorLabs (e.g., Part number t BFL48-200 which is a 200 micron silica core). The fiber is a fiber core made of light conducting material and a cladding material surrounding the fiber core. The cladding material is removed only at the distal ends of the fiber. Light conducting materials include any materials capable of conveying light by multiple internal reflections. Suitable such materials include, for example, plastic materials such as polystyrene, polyacrylate and polymethylmethacrylate materials, and glass materials such as quartz, silica glass, borosilicate glass, lead glass, and fluoride glass materials. A preferred fiber optic material is plastic fibers having diameters from about 200 to about 2000 μm, and glass fibers having diameters from about 50 to about 250 μm. Suitable optical fibers are essentially transparent to the wavelengths of light generated by the light source, may be either single or multi-modal fibers, and may include fibers having specific transmission modes or wavelength bands.

The light source of the disclosed optical sensor device serves to generate light. Preferably, the light source emits light at a wavelength or wavelengths in the red or near-infrared region of the spectrum, that is, for about 600 to about 1500 nm. Examples of suitable light sources include, for example, tungsten light sources, light-emitting diodes composed of gallium arsenide, and laser diodes. Suitable laser diodes include diodes composed of gallium arsenide and aluminum gallium arsenide materials. Such materials are electroluminescent and emit in the near-infrared (i.e., 1050 to 1150 nm) wavelengths.

A preferred embodiment of the disclosed fiber optic liquid level sensor device is made by:

(a) cutting fiber to twice the length of the desired detector to form a single fiber having two ends;

(b) cleaving both ends of the fiber, inspecting under a microscope such that a smooth cut is achieved, because a jagged or fractured cut will cause the detector to fail;

(c) carefully bending the fiber and bringing the two ends together at an approximately equal length, leaving a large loop in the middle;

(d) running the two ends of the fiber through a small hole in an aluminum fixture by slowly pulling both ends through the hole until resistance is felt and the fiber begins to lift back up, wherein the diameter of the hole is from about four times to about 20 times the diameter of the fiber;

(e) while holding the fiber just below the hole in the fixture, heating the looped end of the fiber with a flame heat source (methane, propane, butane, etc.) to allow the fiber to heat up and bend to form a tight loop; and

(f) pulling the fiber having a tight bend through the hole in the fixture.

Optionally the fiber should undergo a quality inspection under a microscope to insure a tight bend was formed and to check for any cracks or fractures in the glass or other material that will affect the performance of the detector.

We claim:

1. An optical sensor comprising a light source, a light detector and signal generator, and two optical fibers having cladding surrounding the fibers except at the distal ends where the distal ends of both fibers are joined.

2. The optical sensor of claim 1 wherein the joining of the distal ends of the optical fibers forms a rounded “V” shape, wherein cladding is removed for from about 0.1 mm to about 5 mm of the distal end from each fiber.

3. The optical sensor of claim 1 wherein the light source is a device selected from the group consisting of LED, tungsten light sources, light-emitting diodes composed of gallium arsenide, and laser diodes composed of gallium arsenide and/or aluminum gallium arsenide materials, phosphors, and combinations thereof.

4. The optical sensor of claim 1 wherein the light detector is a device selected from the group consisting of photo transistor, photo diode, photo cell, electro voltaic cell, phosphors, and combinations thereof.

5. The optical sensor of claim 1 wherein the signal generator is a device selected from the group consisting of LED, Tungsten, Laser, phosphors, and combinations thereof.

6. The optical sensor of claim 1 wherein the two optical fibers are oriented substantially in parallel except at their distal ends where the two optical fibers form a rounded “V” shape.

7. The optical sensor of claim 1 wherein the distal ends of the two optical fibers have had cladding material removed.

8. A process for forming a fiber optic liquid level sensor device, comprising:
(a) cutting fiber optic strand to twice the length of the desired detector to form a single fiber having two ends;
(b) cleaving both ends of the fiber to achieve a smooth cut;
(c) bending the fiber and bringing the two ends together at an approximately equal length, leaving a large loop in the middle;
(d) running the two ends of the fiber through a small hole in an aluminum fixture by slowly pulling both ends through the hole until resistance is felt and the fiber begins to lift back up, wherein the diameter of the hole is from about four times to about 20 times the diameter of the fiber;
(e) while holding the fiber just below the hole in the fixture, heating the looped end of the fiber with a flame heat source to allow the fiber to heat up and bend to form a tight loop; and
(f) pulling the fiber having a tight bend through the hole in the fixture.
